(19) United States
(12) Patent Application Publication
(10) Pub. No.: US 2007/0101559 A1
(43) Pub. Date: May 10, 2007

(54) Funerary receptacle

(76) Inventor: Michael A. Poteet, Happy Valley, OR (US)

Correspondence Address: BANNER & WITCOFF, LTD., 1100 13th STREET, N.W., SUITE 1200, WASHINGTON, DC, 20005-4051, US

(21) Appl. No.: 11/270,013

(22) Filed: Nov. 9, 2005

(51) Int. Cl. A61G 17/00

(52) U.S. Cl. 27/6

(57) ABSTRACT

A funerary receptacle having a chamber for receiving remains of an individual is disclosed. The funerary receptacle is at least partially formed from a material obtained from a man-made military article, and the material may be subjected to a recycling process that alters the material from a first form to a second form. Another aspects of the invention is a method including steps of obtaining a material from a man-made military article, recycling the material, and incorporating the material into the funerary receptacle. A method may also include manufacturing an urn from a material obtained from a man-made military article and supplying the urn to customers with an identifier that identifies a source of the material.

### FIELD OF THE INVENTION

Aspects of the invention generally relate to funerary receptacles for human or animal remains. Aspects of the invention concern, more particularly, a funerary receptacle at least partially formed from a recycled military material.

### BACKGROUND

The passing of an individual may be an emotional and sentimental time for relatives, friends, and other acquaintances of the individual. In mourning the individual, the acquaintances may reminisce about various accomplishments, actions, and other deeds associated with the individual. A common topic discussed and honored by acquaintances of the individual relates to service in the armed forces. For an individual who served in the armed forces, particularly during a time of war, a memorial service often includes a eulogy to honor and remember the individual's military service. In addition, members of the individual's military unit may be in attendance to honor their comrade, a casket for the individual may be draped in a flag, or the individual may be buried or cremated in their military uniform. Accordingly, the passing of an individual may serve as a time to honor and remember the individual's service in the armed forces.

### SUMMARY

Aspects of the present invention relate to honoring the service of an individual in the armed forces. One manner of honoring the individual is with a funerary receptacle having a chamber for receiving remains of the individual, and the funerary receptacle is at least partially formed from a material obtained from a man-made military article. The material may also be subjected to a recycling process that alters the material from a first form to a second form.

Another aspect of the invention is a funerary receptacle having a chamber for receiving one of human and animal remains. The funerary receptacle also includes an identifier that identifies a material forming at least a portion of the funerary receptacle. The material is recycled from a man-made military article, which may be at least one of an aircraft, an ocean-going vessel, a ground vehicle, a weapon for firing a projectile, the projectile, and a casing for the projectile.

Yet another aspect of the invention is a method of manufacturing a funerary receptacle for one of human and animal remains. The method includes steps of obtaining a material from a man-made military article, recycling the material, and incorporating the material into the funerary receptacle. Another method may also include manufacturing an urn from a material obtained from a man-made military article and supplying the urn to customers with an identifier that identifies a source of the material.

The advantages and features of novelty characterizing various aspects of the invention are pointed out with particularity in the appended claims. To gain an improved understanding of the advantages and features of novelty, however, reference may be made to the following descriptive matter and accompanying drawings that describe and illustrate various embodiments and concepts related to the aspects of the invention.

### DESCRIPTION OF THE FIGURES

The foregoing Summary, as well as the following Detailed Description, will be better understood when read in conjunction with the accompanying figures.

FIG. 1 is a perspective view of a first funerary receptacle in accordance with aspects of the invention.

FIG. 2 is another perspective view of the first funerary receptacle.

FIG. 3 is a front elevational view of the first funerary receptacle.

FIG. 4 is a cross-sectional view of the first funerary receptacle, as defined by section line 4-4 in FIG. 3.

FIG. 5 is a front elevational view of an alternate configuration for the first funerary receptacle.

FIG. 6 is a perspective view of a second funerary receptacle in accordance with aspects of the invention.

FIG. 7 is a flow diagram illustrating steps in a first method in accordance with aspects of the invention.

FIG. 8 is a flow diagram illustrating steps in a second method in accordance with aspects of the invention.

### DETAILED DESCRIPTION

The following discussion and accompanying figures disclose concepts related to various funerary receptacles that receive the remains of an individual. Although the funerary receptacles are discussed as urns and caskets, similar concepts may be applied to other types of funerary receptacles, including tombs, mausoleums, and burial chambers, for example. Additionally, the funerary receptacles disclosed below are discussed in terms of receiving human remains, but similar concepts may be applied to funerary receptacles intended for receiving the remains of animals, such as pets. Accordingly, concepts associated with the present invention may be applied to a wide variety of funerary receptacles, whether for human or animal remains.

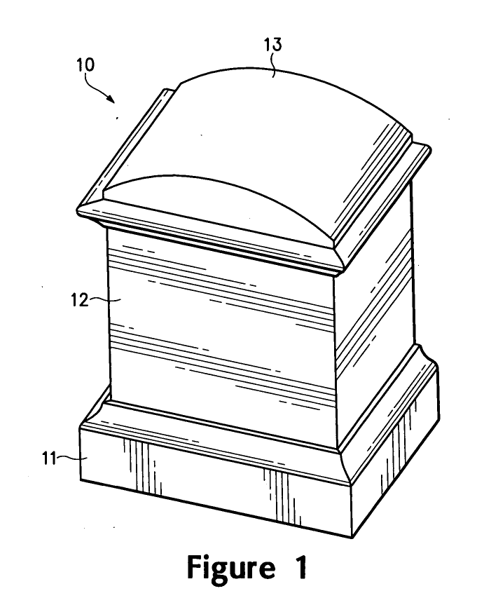

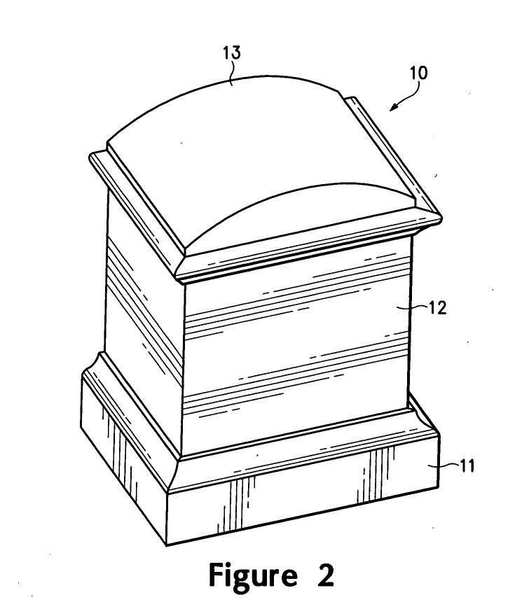

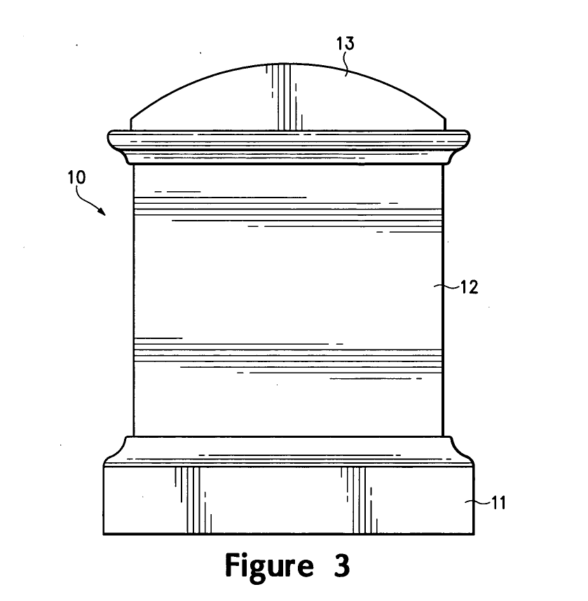

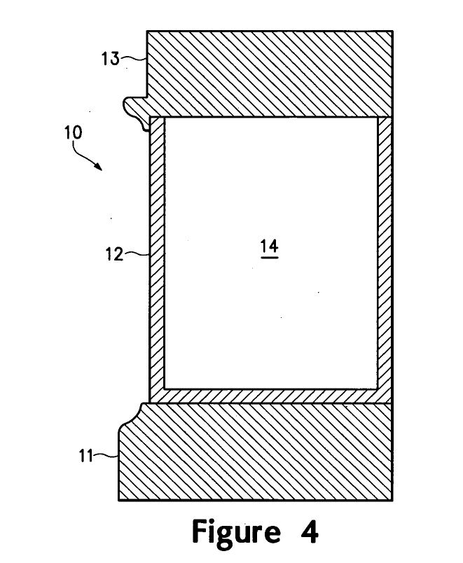

With reference to FIGS. 1-4, a funerary receptacle 10 is disclosed as having a configuration of an urn. Receptacle 10 forms a final and permanent repository for cremated remains of an individual and includes three primary elements: a base 11, a body 12, and a crown 13. Base 11 forms a foundation for receptacle 10 that contacts surfaces upon which receptacle 10 rests. Body 12 is secured to an upper surface of base 11 and defines an interior chamber 14. Crown 13 rests upon or is secured to an upper surface of body 12 and forms a cover for chamber 14. In use, crown 13 may be removed to provide access to chamber 14 and allow the remains to be placed within chamber 14. Crown 13 is then replaced to secure the remains within chamber 14. In order to ensure that crown 13 remains securely-positioned with respect to body 12, various fasteners, an adhesive, or a welding process, for example, may be utilized to join crown 13 to body 12 and effectively seal the remains within chamber 14.

The various portions of receptacle 10 (i.e., base 11, body 12, crown 13) may be formed from one or more of a variety of materials, including various metals, quarried materials (e.g., stone and marble), wood, and polymers, for example. More particularly, a wide variety of metals and metal alloys are suitable for receptacle 10, including iron, steel, copper, brass, nickel, titanium, and various precious metals. Various types of stone or other quarried materials may be used for the various portions of receptacle 10, including marble, granite, jade, and obsidian. Regarding wood, oak, teak, walnut, maple, pine, and cherry, for example, all provide suitable materials for receptacle 10. Regarding polymers, suitable examples include any of the various thermoplastics and thermosets, such as polystyrene, polypropylene, polyether block amide, and nylon. In order to enhance the strength characteristics of the polymers, glass, carbon, or aramid fibers may be added. Various colorants and surface treatments may also be added to enhance the aesthetic appeal.

Mixtures of materials may also be suitable for receptacle 10. For example, two or more of base 11, body 12, and crown 13 may be formed from different materials. As an example, base 11 may be formed from marble, body 12 may be formed from brass, and crown 13 may be formed from oak. Two or more materials may also be utilized for each of base 11, body 12, and crown 13. As an example, base 11 may be formed from a substrate of steel that is coated in a precious metal, such as gold. Crown 13 may also be formed from wood and may include a metal emblem with the information regarding the individual etched therein. Accordingly, a wide variety of materials and material combinations are suitable for receptacle 10.

As discussed above, a variety of materials are suitable for receptacle 10. At least a portion of receptacle 10, however, is formed from a recycled material of military origin. As utilized for purposes of the present invention, a material qualifying as a “recycled material of military origin” incorporates the following two attributes: First, the material was previously incorporated into a man-made article used primarily by the military or individuals associated with the military. Second, the material has been subjected to a recycling process that alters the material from a first form, in which the material was incorporated into the man-made article, to a second form that is suitable for receptacle 10.

A variety of man-made articles used primarily by the military or individuals associated with the military may be utilized for the material of receptacle 10. More particularly, at least a portion of the material of receptacle 10 may be from one or more man-made articles used primarily by the military or individuals associated with the military. As examples, the articles that supply the recycled material of military origin for receptacle 10 may be an aircraft (e.g., transport plane, bomber, fighter jet, and helicopter), an ocean-going vessel (e.g., battleship, submarine, or aircraft carrier), or ground vehicles (e.g., jeep, tank, motorcycle, or armored transport). The articles that supply the recycled material of military origin may also be a weapon for firing a projectile (e.g., handgun, rifle, machine gun), the projectile, or a casing for the projectile. Additionally, the articles that supply the recycled material of military origin may be from helmets, knives, bayonets, grenades, emblems of rank, medical supplies, communications equipment, artillery, or torpedoes, for example. In addition to the various articles discussed above, a plurality of other man-made articles used primarily by the military or individuals associated with the military may be utilized for receptacle 10.

Once a material is obtained from a man-made article, the material is subjected to a recycling process that alters the material from a first form, in which the material was incorporated into the man-made article, to a second form that is suitable for receptacle 10. In general, the recycling process merely changes the form of the material. If, for example, the material is steel, the steel may be melted and cast into one or more of base 11, body 12, and crown 13. When melted, the steel may be mixed with steel or other metals (whether or not of military origin) to form a part of receptacle 10. That is, base 11, body 12, and crown 13 need not be formed from material that is exclusively from the military article, but may be only partially from the military article. In changing the form, steel may also be cold rolled or forged, in addition to melting and casting. As another example, if the material is wood, the form of the wood may be changed through a sanding process or a process that involves cutting the wood into smaller pieces that are joined to form the shape of one or more of base 11, body 12, and crown 13. Similar concepts may be applied to either quarried materials or polymers. In general, therefore, the material from a man-made article used primarily by the military or individuals associated with the military is recycled to change a form of the material.

In order to better understand the definition of recycled material of military origin, various specific examples will now be discussed. One skilled in the relevant art will recognize that these examples are merely intended to provide a better understanding of the definition and are not intended to limit the scope of the invention. A material (e.g., steel) from a decommissioned naval battleship qualifies as a material that was previously incorporated into a man-made article (i.e., the battleship) used primarily by the military (i.e., the Navy). Continuing with the example, if the material from the battleship is melted down to form a part of receptacle 10, then the material would qualify as having been subjected to a recycling process that alters the form of the material. That is, the material is not merely cut from the battleship and incorporated into receptacle 10. Rather, the material is processed or otherwise recycled to change the material from a first form (i.e., as it was incorporated into the battleship) to a second form (i.e., a form that is suitable for receptacle 10).

As a second example, a material forming the barrels (e.g., steel) of one or more machine guns qualifies as a material that was previously incorporated into a man-made article (i.e., the machine guns) used primarily by the military (i.e., the Army, Navy, Air Force, or Marines). Continuing with the example, if the material from the barrels are melted and mixed with other metals (whether or not of military origin) to form a part of receptacle 10, then the material would qualify as having been subjected to a recycling process that alters the form of the material. That is, the material from the barrels is not the only material that forms a part of receptacle 10. Rather, the material from the barrels is combined with other materials or otherwise recycled to change the material from a first form (i.e., as it was incorporated into the barrels) to a second form (i.e., a form that is suitable for receptacle 10).

As a third example, the steel from either the battleship or the barrels, as discussed above, may be cold rolled to change the shape of the material. In general, the shape may be changed from a form that is recognizable as being from the battleship or barrels to another form that is unrecognizable as a part of the battleship or barrels, but is suitable for receptacle 10.

As a fourth example, a material forming the stocks (e.g., wood) of one or more guns (e.g., an M1 Garand) qualifies as a material that was previously incorporated into an man-made article (i.e., the guns) used primarily by the military (i.e., at least the Army). Continuing with the example, if the material from the stocks are cut to form a plurality of pieces that are joined to form a part of receptacle 10 (e.g., base 11 or crown 13), then the material would qualify as having been subjected to a recycling process that alters the form of the material. That is, the material is not recognizable as being a part of the stocks. Rather, the material is cut, joined, sanded, or otherwise recycled to change the material from a first form (i.e., as it was incorporated into the stocks) to a second form (i.e., a form that is suitable for receptacle 10).

As discussed in the Background section above, the passing of an individual serves as a time to honor and remember the individual's service in the armed forces. This may be accomplished through eulogies, having members of the individual's military unit in attendance, draping a flag over a casket, or clothing the individual in their military uniform. Another way of honoring the individual's military service is to form at least a portion of receptacle 10 from a material that was once incorporated into an article utilized by the military, such as an aircraft, an ocean-going vessel, or weaponry, for example. That is, receptacle 10 may include a recycled material of military origin, as discussed above. By forming receptacle 10 to include this type of material, the military service of the individual may be honored by incorporating a part of the individual's history into the final and permanent repository for the remains of the individual.

The recycled material of military origin need not come from a military article directly connected with the individual whose remains will be placed within receptacle 10. For example, receptacle 10 may include a recycled material of military origin obtained from a World War II battleship, whereas the individual served in a ground force in the Korean War. Accordingly, it is not necessary that the individual have direct ties to the military article from which the recycled material of military origin is obtained. In order to further the personalization associated with receptacle 10, however, the recycled material of military origin may be from a military article used (a) by the individual, (b) by the individual's branch of the armed forces, (c) in a conflict that the individual participated in, or (d) in a time period that the individual served in the armed forces, for example. Accordingly, the recycled material of military origin may be selected to form a connection between the individual and the implements used by the individual, by the individual's branch of the armed forces, or at a time when the individual served in the armed forces.

The structure of receptacle 10, as discussed above, is similar to a cremation urn disclosed in U.S. Design Patent D494,727 to Poteet and provides an example of an urn configuration that is suitable for the present invention. A plurality of other urn configurations, whether of conventional or unconventional design, may also be utilized. That is, any shape or configuration for an urn may incorporate a recycled material of military origin. Accordingly, the overall structure of receptacle 10 may vary significantly.

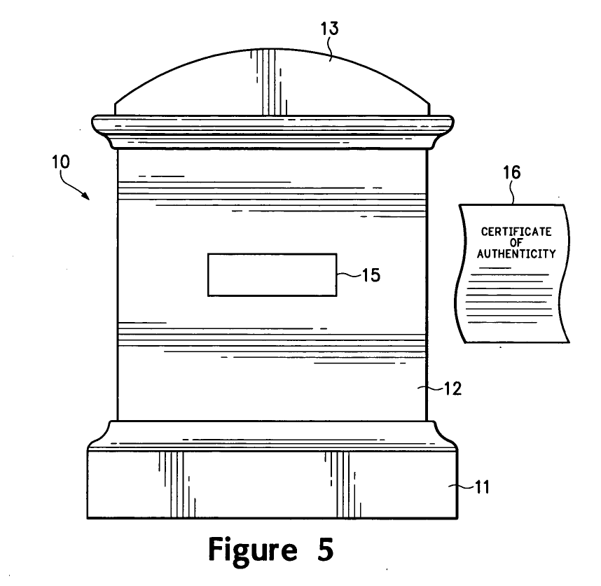

With reference to FIG. 5, another embodiment of receptacle 10 is depicted as including an identifier 15 that generally identifies the recycled material of military origin. As examples, identifier 15 may be a plaque that is affixed to receptacle 10, or identifier 15 may be an etched or engraved area of receptacle 10. In general, identifier 15 identifies the fact that receptacle 10 incorporates a recycled material of military origin and may include information as to the source of the recycled material of military origin. The specificity of the information of identifier 15 may vary significantly. For example, identifier 15 may state that a material of receptacle 10 originated in the armed forces. On a less general level, identifier 15 may state that the material of receptacle 10 was from one of the Army, Navy, Air Force, or Marines, or identifier 15 may state that the material was from one of a battleship, an airplane, or weaponry. If specific, identifier 15 may state that the material of receptacle 10 came from a particular battleship, airplane, or type of weaponry, for example. In some circumstances, identifier 15 may also state that the material of receptacle 10 was from a military article actually used by the individual during the individual's service with the armed forces. As an alternative or in addition to identifier 15, receptacle 10 may be supplied with another type of identifier (i.e., a certificate 16) that provides information similar to identifier 15 or attests to the authenticity of the recycled material of military origin utilized in receptacle 10.

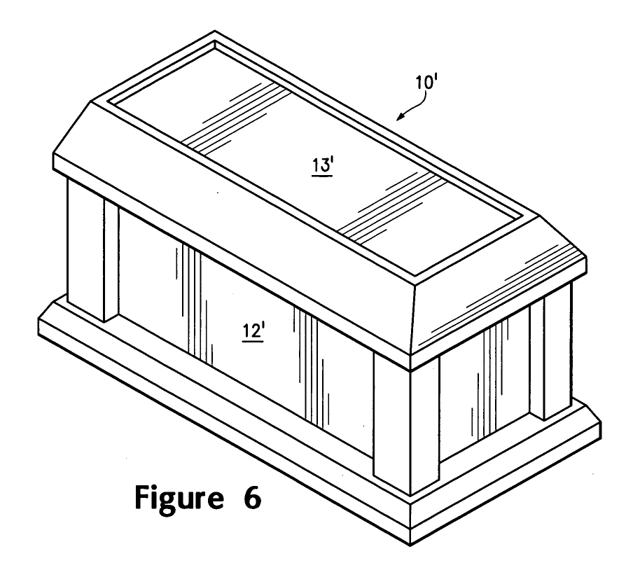

Receptacle 10 is discussed above as having the form of an urn that includes a recycled material of military origin. Similar concepts may be applied to other types of funerary receptacles, including caskets, tombs, mausoleums, and burial chambers, for example. With reference to FIG. 6, a funerary receptacle 10′ is depicted as having a configuration of a casket. Receptacle 10′ has a body 12′ and a cover 13′. Body 12′ forms a lower surface and side surfaces of receptacle 10′ so as to define an interior chamber (not depicted) for receiving remains. Cover 13′ may have a hinged structure that opens to reveal the chamber and closes to seal the chamber.

As with receptacle 10, receptacle 10′ may be formed from a variety of materials, including various metals, quarried materials (e.g., stone and marble), wood, and polymers, for example. At least a portion of receptacle 10, however, is formed from a recycled material of military origin. That is, one or both of body 12′ and cover 13′ may include the recycled material of military origin, in addition to various other materials. Furthermore, hinges joining cover 13′ to body 12′ or handles for carrying receptacle 10′ may be formed from the recycled material of military origin.

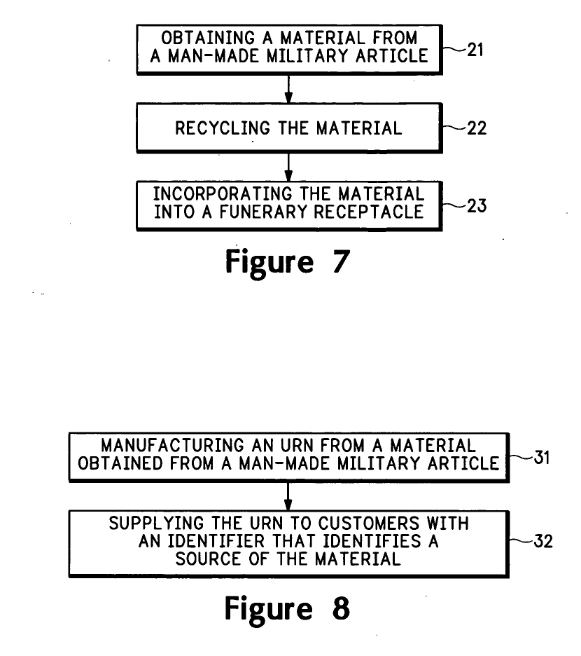

With reference to FIG. 7, a flow diagram illustrating steps in a method for manufacturing a funerary receptacle, such as receptacle 10, is shown. The method involves a step of obtaining a material from a man-made military article (Step 21). The material may be from any of the military articles discussed above, including an aircraft, an ocean-going vessel, a ground vehicle, a weapon for firing a projectile, the projectile, and a casing for the projectile. In some circumstances, a particular individual or the acquaintances of a deceased individual may desire to have material from a type of military article or specific military article. For example, an individual may with to have a funerary receptacle formed from a type of equipment the individual used when in the armed forces, or the individual may want the material to come from a specific military article that the individual was associated with while in the armed forces. Accordingly, the method may include receiving instructions from an individual relating to the source of the material.

The method also includes recycling the material (Step 22). As discussed above, the material is subjected to a recycling process that alters the material from a first form, in which the material was incorporated into the man-made article, to a second form that is suitable for receptacle 10. In the case of metals, for example, this may involve melting the metal and casting the metal into a shape that is appropriate for receptacle 10. In some circumstances, this may involve mixing the metal with other metals, whether from a military or non-military origin.

Finally, the method includes incorporating the material into a funerary receptacle (Step 23). If the material is cast into one or more of base 11, body 12, or crown 13, then these elements may be assembled to incorporate the material into the funerary receptacle. In some circumstances, the material may be applied as a plating to surfaces of the funerary receptacle. For example, the coating may be applied to an exterior of the funerary receptacle, or the coating may be used to line a chamber within the funerary receptacle. An advantage of utilizing the material as a coating is that the material is readily visible from the exterior or is in direct contact with the remains within the chamber.

With reference to FIG. 8, another flow diagram illustrating steps in a method is shown. The method involves a step of manufacturing an urn from a material obtained from a man-made military article (Step 31), which is discussed at length above. The method also includes supplying the urn to customers with an identifier that identifies a source of the material (Step 32). FIG. 5 depicts receptacle 10 as including both an identifier 15 and a certificate 16. Both of these identifiers may be used to identify the source of the material.

Funerary receptacles that incorporate a recycled material of military origin, such as receptacles 10 and 10′, may be utilized to honor the service of an individual in the armed forces. The passing of an individual serves as a time to honor and remember the individual's service in the armed forces. By forming receptacles 10 and 10′ to include a recycled material of military origin, the military service of the individual may be honored by incorporating a part of the individual's history into the final and permanent repository for the remains of the individual.

The invention is disclosed above and in the accompanying drawings with reference to a variety of embodiments. The purpose served by the disclosure, however, is to provide an example of the various features and concepts related to aspects of the invention, not to limit the scope of aspects of the invention. One skilled in the relevant art will recognize that numerous variations and modifications may be made to the embodiments described above without departing from the scope of the invention, as defined by the appended claims.

That which is claimed is:

1. A funerary receptacle comprising a chamber for receiving one of human and animal remains, the funerary receptacle being at least partially formed from a material obtained from a man-made military article.

2. The funerary receptacle recited in claim 1, wherein the material has been subjected to a recycling process that alters the material from a first form to a second form.

3. The funerary receptacle recited in claim 1, wherein the material is a metal.

4. The funerary receptacle recited in claim 1, wherein the man-made military article is selected from a group consisting of an aircraft, an ocean-going vessel, and a ground vehicle.

5. The funerary receptacle recited in claim 1, wherein the man-made military article is selected from a group consisting of a weapon for firing a projectile, the projectile, and a casing for the projectile.

6. The funerary receptacle recited in claim 1, wherein the funerary receptacle defines an exterior surface, and the material forms at least a portion of the exterior surface.

7. The funerary receptacle recited in claim 1, wherein the chamber defines an interior surface of the funerary receptacle, and the material forms at least a portion of the interior surface.

8. The funerary receptacle recited in claim 1, further comprising an identifier that states a source of the material.

9. The funerary receptacle recited in claim 1, further comprising a certificate that states a source of the material.

10. The funerary receptacle recited in claim 1, wherein the material is mixed with a material not from the man-made military article.

11. A funerary receptacle comprising a chamber for receiving one of human and animal remains, the funerary receptacle being at least partially formed from a recycled material of military origin.

12. The funerary receptacle recited in claim 11, wherein the recycled material of military origin is a material that:
is from a man-made article used by the military or individuals associated with the military; and
has been subjected to a recycling process that alters the material from a first form to a second form.

13. The funerary receptacle recited in claim 12, wherein the man-made article is selected from a group consisting of an aircraft, an ocean-going vessel, and a ground vehicle.

14. The funerary receptacle recited in claim 12, wherein the man-made article is selected from a group consisting of a weapon for firing a projectile, the projectile, and a casing for the projectile.

15. The funerary receptacle recited in claim 11, wherein the recycled material of military origin is a metal.

16. The funerary receptacle recited in claim 11, wherein the funerary receptacle defines an exterior surface, and the recycled material of military origin forms at least a portion of the exterior surface.

17. The funerary receptacle recited in claim 11, wherein the chamber defines an interior surface of the funerary receptacle, and the recycled material of military origin forms at least a portion of the interior surface.

18. The funerary receptacle recited in claim 11, further comprising an identifier that states a source of the recycled material of military origin.

19. The funerary receptacle recited in claim 11, further comprising a certificate that states a source of the recycled material of military origin.

20. The funerary receptacle recited in claim 11, wherein the material is mixed with a material not of military origin.

21. A funerary receptacle comprising (a) a chamber for receiving one of human and animal remains and (b) an identifier that identifies a material forming at least a portion of the funerary receptacle, the material being recycled from a man-made military article, the man-made military article being at least one of a group consisting of an aircraft, an ocean-going vessel, a ground vehicle, a weapon for firing a projectile, the projectile, and a casing for the projectile.

22. The funerary receptacle recited in claim 21, wherein the material is a metal.

23. The funerary receptacle recited in claim 21, wherein the funerary receptacle defines an exterior surface, and the recycled material of military origin forms at least a portion of the exterior surface.

24. The funerary receptacle recited in claim 21, wherein the chamber defines an interior surface of the funerary receptacle, and the recycled material of military origin forms at least a portion of the interior surface.

25. The funerary receptacle recited in claim 21, wherein the material is mixed with a material not from the man-made military article.

26. A method of manufacturing a funerary receptacle for one of human and animal remains, the method comprising steps of:
obtaining a material from a man-made military article;
recycling the material; and
incorporating the material into the funerary receptacle.

27. The method recited in claim 26, wherein the step of obtaining includes acquiring the material from at least one of a group consisting of an aircraft, an ocean-going vessel, a ground vehicle, a weapon for firing a projectile, the projectile, and a casing for the projectile.

28. The method recited in claim 26, further including a step of selecting the material to be a metal.

29. The method recited in claim 28, wherein the step of recycling includes melting the metal.

30. The method recited in claim 26, further including a step of receiving instructions from an individual relating to the source of the material.

31. A method comprising steps of:
manufacturing an urn from a material obtained from a man-made military article; and
supplying the urn to customers with an identifier that identifies a source of the material.

32. The method recited in claim 31, wherein the step of supplying includes locating the identifier on a surface of the urn.

33. The method recited in claim 31, wherein the step of supplying includes providing the identifier as a certificate that is separate from the urn.
